(19) United States
(12) Patent Application Publication
(10) Pub. No.: US 2016/0328197 A1
(43) Pub. Date: Nov. 10, 2016

(54) VEHICLE DATA ENFORCEMENT AND CONTEXTUAL INTERFERENCE MODULE FOR IN-VEHICLE APP DEVELOPMENT

(71) Applicant: GM GLOBAL TECHNOLOGY OPERATIONS LLC, DETROIT, MI (US)

(72) Inventors: FAN BAI, ANN ARBOR (MI); DONALD K. GRIMM, UTICA, MI (US); LEONARD C. NIEMAN, WARREN, MI (US); ROBERT A. HRABAK, WEST BLOOMFIELD, MI (US); CEM U. SARAYDAR, BIRMINGHAM, MI (US)

(21) Appl. No.: 14/703,101

(22) Filed: May 4, 2015

(51) Int. Cl. G06F 3/14; G07C 5/00

(52) U.S. Cl. CPC G06F 3/14; G07C 5/008

(57) ABSTRACT

A method for rendering vehicle information includes receiving from an application of a user device a request for information. The request identifies the application requesting vehicle information. A filter is applied to determine whether the requested information is allowable information. The allowable information includes information that the vehicle is authorized to output to the user device. A format-type of information is determined to be output to the user device. A quality level of information is determined to provide to the user device. The quality level of information determined as a function of variable parameters in response to the requested information being allowable information. The vehicle information is processed as a function of the quality level of information and the format-type of information. The processed vehicle information is output to the user device.

### BACKGROUND OF INVENTION

An embodiment relates to data sharing devices.

More devices such as smart phones, tablets, computers and the like use mobile applications. Such mobile applications typically require access to certain features within the phone to gather information to execute the application and also request external sources to provide information to execute the application. As a result, data sharing is a technique where devices request data from other devices to make informed decisions when executing an application.

While this appears to be a good concept to freely data share, the downside of data sharing is the burden it may place on the device providing the information. A device's resources may be heavily burdened if various devices are constantly requesting data. Moreover, various requesting devices may request data beyond what an application actually needs. In such cases, an application may be fishing for data, or may be maliciously trying to request data to tie up resources, or may be trying to obtain personal or private information.

As a result, having an open policy to disseminate information freely, without any restrictions, can lead to overburdening systems in terms of resource usage and power consumption, and may enable various forms of malicious intent, such as the distribution of private information or other types of unwanted system access.

### SUMMARY OF INVENTION

An advantage of an embodiment is a method of selectively determining whether information can be shared with other devices as well as the type of information and the amount of information. The techniques described herein determine whether the information requested is allowable information or disallowable information. Thereafter, the system/device from which the information is being requested can determine what information is actually needed based on variables communicated to it from the requesting device. Moreover, the device can determine a level of quality of information that may be provided and the format that the information may be provided. For example, the device can determine whether raw data or context level information is being requested. Furthermore, the device can determine the level of quality of the information which it determines the requesting device needs and processes such information into a format that it determines is conducive to the needs of the application of the requesting device.

An embodiment contemplates a method of rendering vehicle information. A request for information is received from an application of a user device. The request identifies the application requesting vehicle information. A filter is applied by a vehicle information rendering module to determine whether the requested information is allowable information. Allowable information includes information that the vehicle is authorized to output to the user device. A format-type of information to be output to the user device is determined by the vehicle information rendering module. A quality level of information to provide to the user device is determined by a vehicle information rendering module. The quality level of information is determined as a function of variable parameters in response to the requested information being allowable information. The vehicle information is processed as a function of the quality level of information and the format-type of information. The processed vehicle information is output to the user device.

### BRIEF DESCRIPTION OF DRAWINGS

FIG. 1 is a illustrates a portable device to vehicle head unit data exchange system

FIG. 2 is a vehicle information rendering module.

FIG. 3 a flow diagram of a filter configuration of the QoS decision module

FIG. 4 is a context tree of different QoS grades.

FIG. 5 is a flowchart for determining a type and amount of rendering for generating requested information.

### DETAILED DESCRIPTION

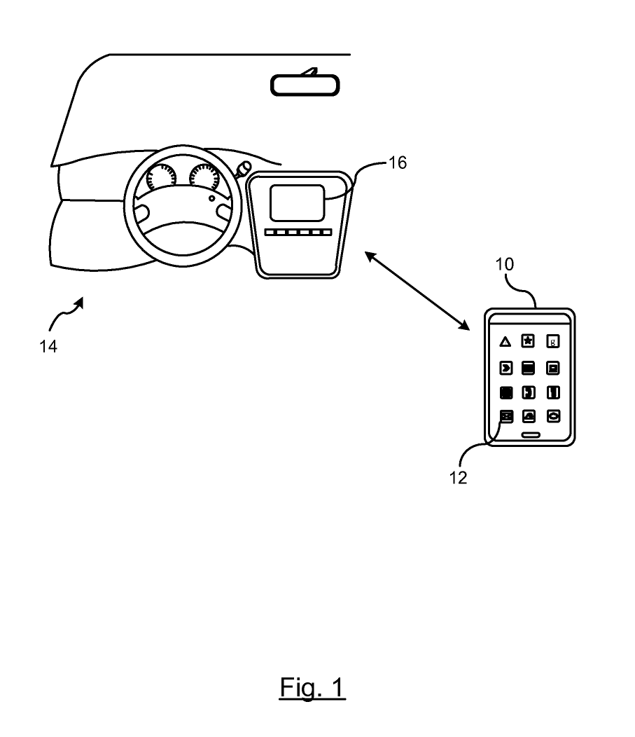

FIG. 1 illustrates a portable device to vehicle head unit data exchange. A portable device 10 includes mobile applications 12 loaded on the portable device. The portable device 10 utilizes a mobile operating system platform and advanced application programming interfaces (APIs) for running mobile applications. The mobile applications include software applications that are designed to run on various types of mobile computing devices. These mobile applications are available through application distribution platforms. Mobile applications are downloaded from the digital distribution platform to the portable device. Certain applications when executing their primary function require data from other devices such a vehicle 14. Under the paradigm described here, the vehicle 14 may be part of the Internet of Things (IoT), and when considered as a connected device, participate in data exchanges with other devices. It should be understood that the portable device and the vehicle are only examples of respective devices/systems sharing data, and apply to other types of devices or systems including, but not limited to, planes, trains, ships, fixed entities.

The IoT is a network of physical objects embedded within electronics, software, sensors, and by the use of wireless or wireline connectivity, enables other sources to achieve added value and service by exchanging data with other parties or other connected devices. Such sources provide advanced, and in many instances, automated information sharing with respect to a variety of electrical devices for which data may be monitored and obtained. The concept associated with IoT is to collect useful data with the assistance of various existing technologies and then autonomously convey the information and data between other devices. As a result, a plethora of information and data is generated from diverse locations which are aggregated quickly. Typically, such information is openly obtained; however, the advantage as described herein places limits on the type and quantity of data that may be obtained.

The vehicle 14 collects various types of vehicle operational data that can be utilized by various mobile applications. However, the vehicle 14 can selectively determine which data it wants to share with the portable device 10 and the amount of data that may be shared.

The vehicle 14 includes a head unit 16 or other controlling unit that communicates with the portable device 10. The portable device 10 includes a mechanism that identifies the device and the application that is requesting the information, and based on various parameters associated with the application, a determination is made by the vehicle information rendering module as to whether the portable device 10 is provided access to the information, and if so, to what level or degree.

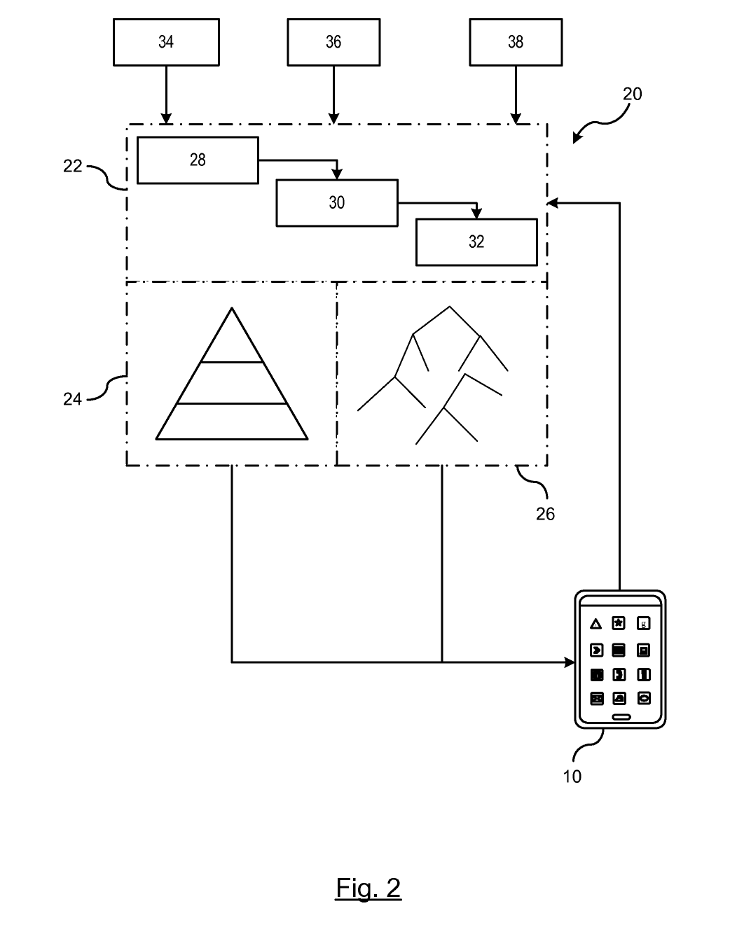

FIG. 2 illustrates the vehicle information rendering module shown generally at 20. The portable device 10 is in communication with a vehicle information rendering module 20 via the vehicle head unit. It should be understood that the portable device 10 may communicate with the vehicle head unit via a wireline connection. It is not pertinent as to how the information is shared between the devices (e.g., wirelessly or wireline), but the embodiments herein control the level of context that is to be provided to the application of the portable device 10. In addition, an assumption is made that each of the devices includes security processes that mutually authenticate one another for authorized communication and exchange of data. Any type of authentication scheme may be utilized herein without deviating from the scope of the invention.

The vehicle information rendering module 20 includes a control plane module 22, a data plane module 24, and a context plane module 26. The control module 22 determines whether information is provided from the data plane module 24 or the context plane module 26. If the data plane module 24 is selected, then raw data is provided to the wireless device. If the context plane module 26, then raw data is processed and converted to context-formatted information.

The control plane module 22 includes a data category filter sub-module 28, a data format decision sub-module 30, and a data quality of service (QoS) sub-module 32.

The data category filter module 28 is a filter that can determine whether the data requested by the portable device 10 (e.g., smart phone Apps) belongs to an allowed data category that can be provided to the portable device 10, or whether the data belongs to a disallowed data category in which case the vehicle data will not provide to portable device 10 due to reasons that include, but are not limited to, privacy concerns, security concerns, or business concerns. The data category filter module 28 could be implemented as a database function that allows data to be shared only if there is a match between the data-type requests of the portable device and the vehicle.

The data format decision module 30 determines if the raw data or the processed synthetic context information should be provided to the portable device. For example, some data requests may only need the raw data which will be provided by the data plane. As a result, no processing (or minimal processing) is required when raw data is provided. The only determination that will be required is the level of resolution and the sampling rate of data. If context data is required, the data plane module 24 will provide raw data to the context plane module 26 for processing the raw data and converting the data to context level data.

The data QoS decision module 32 determines the level of service that is provided to the portable device 10. Data typically obtained from vehicle systems and subsystems is raw data. If raw data is provided, then the QoS will cooperatively work with the data plane module 24 to determine a level of resolution and sampling rate of the raw data supplied to the portable device.

However, supplying raw data to the portable device 10 may involve excess data (in terms of accuracy and/or frequency) that the portable device 10 does not actually need and may burden the resource capabilities of the vehicle in providing the data. As a result, the QoS module decision module 32 determines a quality level that will be provided for a specific data flow to the portable device 10, such as high-grade quality data, medium-grade quality data, or low-grade quality data. High-grade quality data includes high resolution data of sufficient accuracy and/or update frequency that enables the portable device to obtain accurate results. Medium-grade quality data is data that is less detailed and/or less timely than the high-grade quality data. Low-grade quality data is data that is less detailed than the medium grade quality data and/or provided less frequently. As can be understood, the data quality level can be easily implemented to support variable levels of data quality beyond the three examples that are described here. The QoS decision module implements the above functionality utilizing two tuning parameters: a first tuning parameter is a resolution tuning parameter and a second tuning parameter is a sampling rate parameter. The resolution tuning parameter can be adjusted to obtain a respective degree of resolution to achieve the targeted level of quality. In addition, the sampling rate parameter may be adjusted to sample at a rate for obtaining the desired quality level.

The determination of what quality level of data is utilized is determined by (1) Application needs, (2) system resource network bandwidth and (3) business logic/policy.

Application needs 34 provide the demands of the application, which includes what information the mobile application is requesting. An application that is requesting a plethora of information may be merely fishing for information and does not necessarily need all the information to support its core functionality, which is a waste of time and resources for the vehicle providing the information. As a result, the vehicle information rendering module 20 can make its own assessment of what information the mobile application may need based on the needs of the application and details indicating what the information will be used for.

Resource/capabilities input 36 may include resource capabilities and constraints that include, but are not limited to, communication bandwidth, processing power, storage, memory allocation, data rate limit, and channel capacity.

Business policy input 38 may include business parameters that determine whether any information should be provided as well as the amount of information provided based on business decisions. Business policies may include compensation that is being provided to the vehicle in exchange for the information. Compensation may be money that is paid per usage, or a subscription, or may be a quid pro quo where exchange of data is provided both ways.

Referring to the data format module 24, if the data format module determines that context-level information is required, then the data plane module 24 provides raw data to the context plane module 26 for generating context-level information. Context-level information is data that is processed to so that the information can be readily understood and assessed for which it applies to. Context level-information utilizes sensors and other devices to perceive a situation by abstracting information from data while understanding the context for which the data applies. For example, a user's activity and location may be pertinent for many applications, and as a result, context derived analysis may utilize analysis, awareness, and recognitions of a situation that is derived by processing the raw data, and not just viewing the data from its raw form. As described earlier, based on the input parameters such as the (1) Application needs, (2) system resources, and (3) inherent business logic/policy, the data QoS decision module 38 in cooperation with the context plane module 26 determines the QoS context level information that should be provided. Examples of varying degrees of context level information may include, but is not limited to, low-level context information, medium-context level information, or high-level context information. Low-level context is raw data where only a minimal amount of processing is required to make the information readily usable or understandable to the application. Such information may include speed of the vehicle, whether braking is occurring, acceleration is occurring, or whether it is raining outside. Medium-level context and high-level context provides greater details that requires additional analysis by the vehicle such as whether the driver is drowsy or whether the vehicle will need gas based on driving behaviors of the driver.

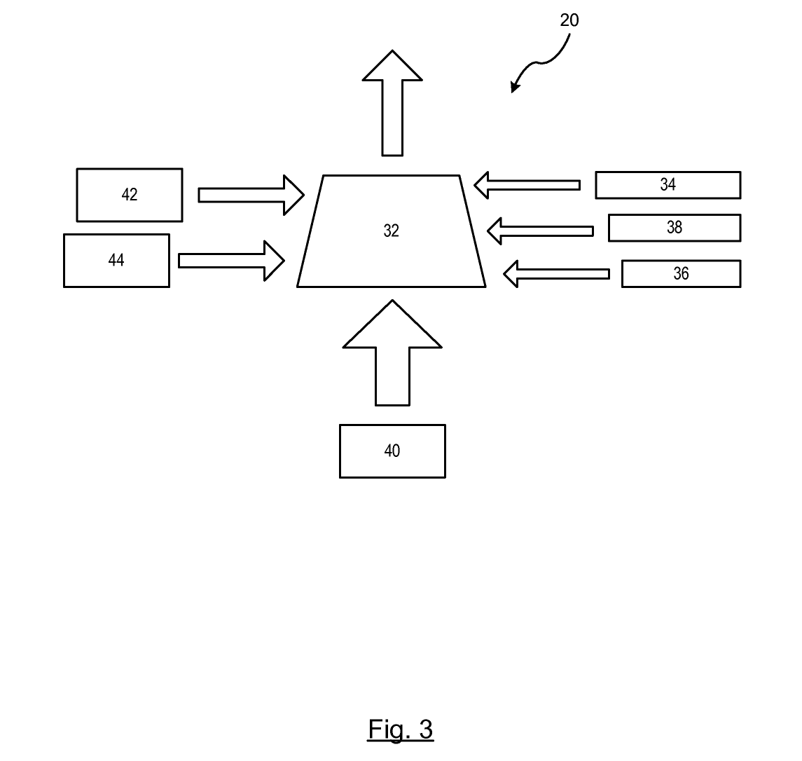

FIG. 3 illustrates a flow diagram of a filter configuration of the QoS decision module. As shown, raw data 40 is input to the data QoS decision module 32. As described earlier, the various inputs such as the mobile application needs 28, the system resource/capabilities input 30, and the business policy 32 are used to determine the amount of information and level of context the vehicle provides if context level data is required.

The QoS decision module 32 then tunes the data to a respective quality level using parameters that include, but are not limited to, data resolution parameters 42 and data sampling rate parameters 44. Data resolution parameters 42 provide how accurate the data should be. If the accuracy is of importance where detailed information is required, then the QoS decision module 32 will be tuned to provide high resolution of data, whereas if accuracy of data is not as pertinent where only coarse information is required, then a lower resolution is provided.

Data sampling rate parameters 44 pertains to the frequency rate at which data is required. For example, collision alert systems require that data be obtained at an very high rate (e.g., 100 ms) due to the changing environment that can change at any given point in time, whereas data from a fuel level sensor (e.g., for display purposes) can be sampled less frequently. As a result, the data sampling rate parameters 44 provide input as to the suggested rate of input.

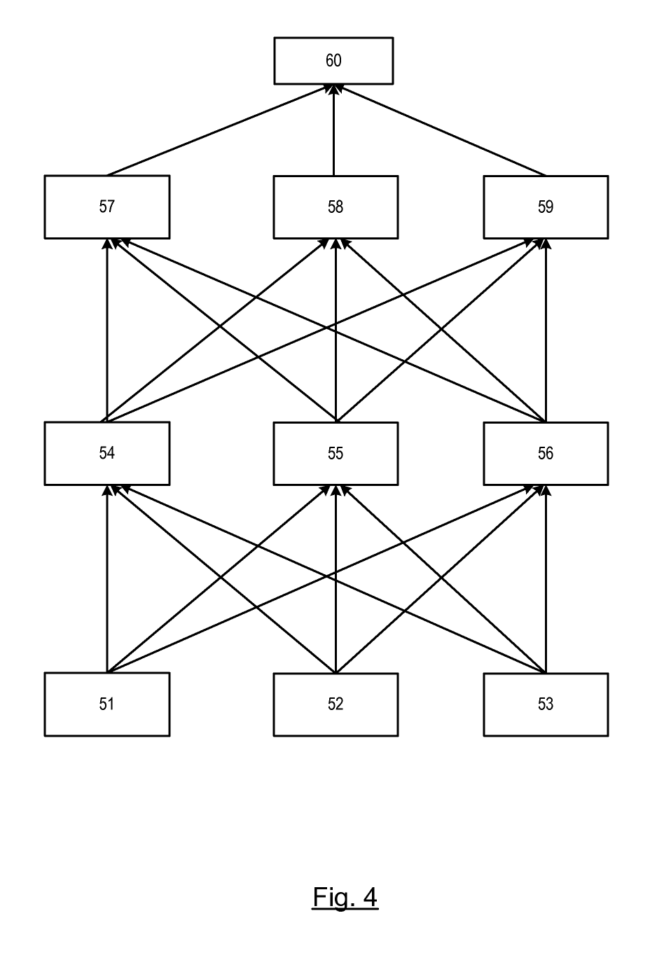

FIG. 4 illustrates a context tree of different QoS levels. Data is retrieved by a plurality of sources 50 both within the vehicle and exterior of the vehicle for determining a level of context that is output from the vehicle. Examples of sources include, but are not limited to, vehicle CAN sensor data 51 from the vehicle, smart phone sensor data 52 from the portable device, and external internet information 53 that may relate to such factors as the environment exterior of the vehicle.

The tree includes a hierarchical order of context levels where each context level transitioning up the tree includes greater detail of context information that is obtained by processing preceding level context information. Each context level includes categories relating to various attributes in which context can be derived from. In a respective category, driver information relating to the driver's driving actions may be obtained. As shown in FIG. 4, a low-level driver context 54 is determined from data from the plurality of sources 50. Low-level driver context 54 relates to the driver's driving actions such as whether the driver executes sharp turns as opposed to gradual turns, initiates sudden braking as opposed to gradual braking, and sudden accelerations as opposed to gradual accelerations. Such context information can readily be obtainable from sensors with minimal processing required by the vehicle in order to analyze the data and forward to the portable device.

Low-level vehicle context information 55 includes information relating to the operating conditions of the vehicle. Such information may include, but is not limited to, vehicle speed, fuel level, and cruise control activation.

Low-level vehicle environment context 56 includes environmental information relating to environmental conditions exterior of the vehicle. Such information may include, but is not limited to, weather conditions such as rain, fog, and snow.

Data used for determining low-level context information for all low-level context categories will be retrieved directly from the plurality of sources 50. As shown, in FIG. 4, each of the low-level context categories can obtain information directly from each respective source.

If a determination is made that a next higher level context relative to the lower level context is needed, then each next level context category will obtain data directly from the previous level context. As shown in FIG. 4, a next higher-level driver context 57 is determined from data supplied directly from the any of the categories in the direct previous context level. The next higher-level driver context 57 may relate to a driver's driving actions such as whether the driver is drowsy, distracted, or tired. Such information often includes some type of driver recognition device or may be determined based on driving behavior of the driver (e.g., changing speeds while swerving). The next higher-level driver context 57 may receive input from the direct previous contexts that include, but are not limited to, the low-level driver context 54, low-level vehicle context 55, and low-level environmental context 56.

Similarly, a next higher-level vehicle context 58 may relate to higher level vehicle operating conditions such as determining whether the driver needs more fuel or whether maintenance is required. Such information requires more in-depth analysis. For example, determining whether the driver needs gas may be a function of analyzing fuel usage rate that is based on variables that include, but are not limited to, the driver driving behavior, the area the driver is driving in, and whether there are other refueling stations along the current driving route. In addition, maintenance may be indicative of how the vehicle is being operated such as a driver that accelerates quickly, brakes hard, and turns sharply, which will require a tire rotation sooner than a driver that drives a vehicle more mildly. It should be understood that conditions at the higher-level context require additional analyzing and processing of data as opposed to obtaining results directly from raw data.

A next higher-level environment context is shown generally at 59. The next higher-level environmental context 59 may provide information that identifies environmental conditions that impose challenging driving tasks to the driver. The various lower-level contexts may provide details for determining whether the driving task is challenging, which may take into consideration the road contour (based on the driver's steering), traffic congestion, environmental visibility, or road surface condition. The type of context determined here requires additional analyzing and processing which is more in-depth than what the raw data provides.

It should be understood that each of the high-level context categories receives input from previous contexts that include, but are not limited to, the low-level driver context 54, low-level vehicle context 55, and low-level environmental context 56.

The respective information is provided to a synthetic context engine 60 which is based on the determined level of resolution and level of context. The synthetic context engine 60 transmits the information to the portable device.

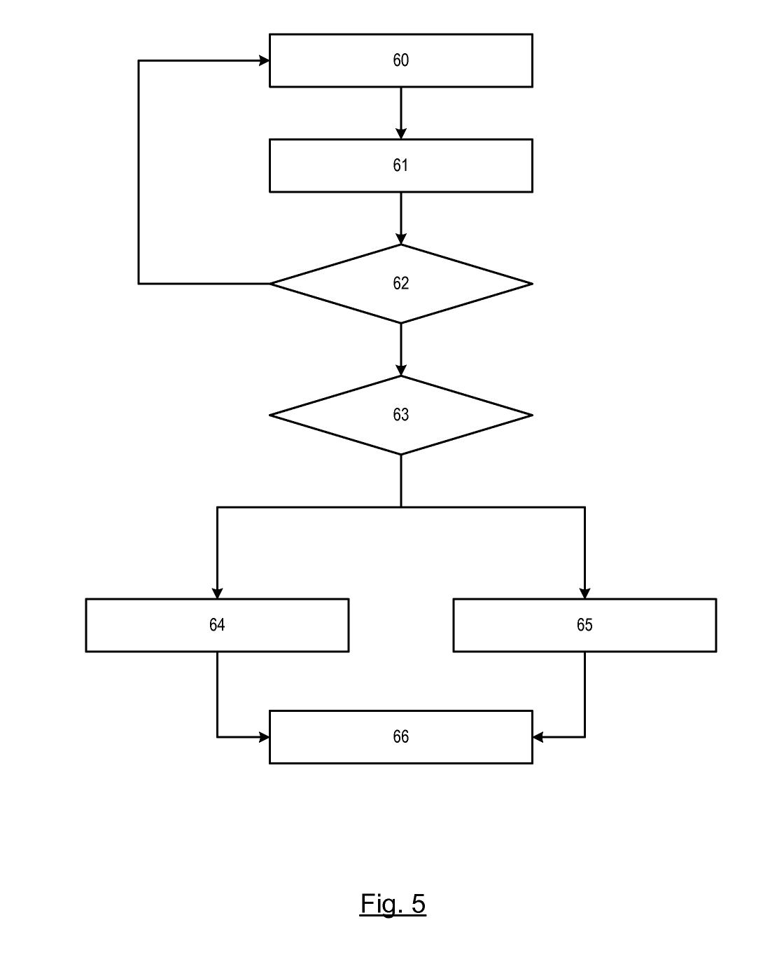

FIG. 5 illustrates a flowchart for determining a type and amount of rendering that is required of raw data for supplying information from an information gathering system to an information requesting system.

In block 60, a device (e.g., portable device) requests information from an information monitoring system (e.g., vehicle). It should be understood that other devices and systems may be utilized aside from the portable device and vehicle without deviating from the scope of the invention.

In block 61, the vehicle determines the type of application requesting the information and what information is being requested.

In block 62, the vehicle applies a data category filter to determine whether the requested data belongs to an allowed data category that can be provided to the portable device or whether the requested data belongs to a disallowed data category. Disallowed information may be data that is restricted due to privacy concerns, security concerns, or business concerns. Business concerns may be data that is restricted unless otherwise paid for or meets other types of requirements such as a mutual exchange of data with another entity. In the case of the vehicle and portable device, this process could be implemented as a database for matching a portable device requested data type to an OEM allowed data type that is allowed to be shared.

If the determination is made in block 62 that the information is disallowed information, then a return is made to block 60 to wait for a next request. If the determination is made that information is allowed information, then the routine proceeds to step 63.

In block 63, a data formal decision module determines whether the information should be provided as raw data or context data. The decision is based on the type of data being requested as well as business decisions.

In block 64, in response to a determination that the raw data is required, the QoS decision module adjusts two tuning parameters for generating the quality level of data being provided. A first parameter includes resolution and a second parameter includes sampling rate. The quality level of the raw data is determined by the (1) application needs, (2) the system resource network bandwidth, and (3) business logic/policies. After a determination is made as to the QoS level of the data (e.g., low, medium, or high level QoS data), the tuning parameters are adjusted for generating the level of the quality raw data. For example, if low quality data is required, then low resolution and a low sampling rate of the raw data is utilized. The routine proceeds to block 66 where the data is output to the portable device.

In block 65, in response to a determination that context-level data is required, then raw data from the data plane module is provided to a QoS decision module to determine the level of context information. The quality level for the context data is determined by the (1) application needs, (2) the system resource network bandwidth, and (3) business logic/policies. After a determination is made as to the QoS level of the data (low, medium, or high level QoS context data), the raw data is processed by the context engine for generating the level of context data provided to the portable device. The context level of data provided to the portable device may one of a plurality of varying levels of context. The tree structure illustrated in FIG. 4 is exemplary and the levels of context may include less or more than what is shown. The routine proceeds to block 66 where the data is output to the portable device.

While certain embodiments of the present invention have been described in detail, those familiar with the art to which this invention relates will recognize various alternative designs and embodiments for practicing the invention as defined by the following claims.

What is claimed is:

1. A method for rendering vehicle information comprising the steps of:
receiving from an application of a user device a request for information, the request identifying the application requesting vehicle information;
applying a filter, by a vehicle information rendering module, to determine whether the requested information is allowable information, allowable information including information that the vehicle is authorized to output to the user device;
determining, by the vehicle information rendering module, a format-type of information to be output to the user device;
determining, by a vehicle information rendering module, a quality level of information to provide to the user device, the quality level of information determined as a function of variable parameters in response to the requested information being allowable information;
processing the vehicle information as a function of the quality level of information and the format-type of information, and;
outputting the processed vehicle information to the user device.

2. The method of claim 1 wherein the filter determines whether the requested information is one of allowed information or disallowed information, wherein the vehicle information rendering module does not transmit the requested information to the user device in response to determining the requested information is disallowed information.

3. The method of claim 1 further comprising the step of determining whether the format-type of information output to the user device utilizes raw data or synthetic context level data by a data format decision module of the vehicle information rendering module.

4. The method of claim 3 wherein the quality level of information identifies a respective level of quality that is provided to the user device, the level of quality determined as a function of variable parameters.

5. The method of claim 4 wherein the variable parameters used to determine the level of quality for the information includes application needs and data accuracy requirements.

6. The method of claim 5 wherein the variable parameters used to determine the level of quality for the information includes available resource capabilities of the vehicle.

7. The method of claim 6 wherein the variable parameters used to determine the level of quality for the information includes a business policy established between the vehicle and the user device.

8. The method of claim 7 wherein in response to a determination of using raw data, the quality level of information is generated by adjusting quality parameters to tune the raw data to the level of quality as determined.

9. The method of claim 8 wherein the quality parameters include a data resolution parameter, wherein the data resolution parameter adjusts a resolution to generate the determined level of quality.

10. The method of claim 8 wherein the quality parameter includes a data sampling rate parameter, wherein the data sampling rate parameter adjusts a sampling rate to generate the determined level of quality.

11. The method of claim 7 wherein in response to a determination of using context level data, a respective context level is selected from a plurality of context levels, wherein the plurality of context levels each include varying degrees of processing information and intelligence for generating the quality level of information.

12. The method of claim 11 wherein the quality level of information is provided to users to develop mobile applications, wherein users include application developers.

13. The method of claim 11 wherein each respective context level includes a plurality of context level categories, each category relating to attributes where context level information is derived relating to each attribute.

14. The method of claim 13 wherein the plurality of categories includes context level information having a degree of details relating to the attribute at each respective context level, wherein each context level has a hierarchical order, and wherein information is processed in greater detail as the hierarchical order increases at each context level for each category.

15. The method of claim 14 wherein each respective category in a respective context level selectively obtains data from any of the respective categories in a context level directly preceding the respective context level.

16. The method of claim 15 wherein respective categories in a lowest context level of the hierarchical order obtains raw data from a plurality of sources for generating context level information.

17. The method of claim 16 wherein the plurality of sources includes sensors providing data to generate the context level information.

18. The method of claim 17 wherein the plurality of sources includes smart devices providing data to generate the context level information.

19. The method of claim 15 wherein the plurality of sources includes vehicle based devices providing data to generate the context level information.

20. The method of claim 15 wherein the plurality of sources includes non-vehicle based devices providing data to generate context level information.
